(19) United States
(12) Patent Application Publication
(10) Pub. No.: US 2009/0070170 A1
(43) Pub. Date: Mar. 12, 2009

(54) SYSTEM AND METHOD FOR RISK ASSESSMENT AND MANAGEMENT

(76) Inventor: Natarajan KRISHNAMURTHY, Singapore (SG)

Correspondence Address: GREENBLUM & BERNSTEIN, P.L.C., 1950 ROLAND CLARKE PLACE, RESTON, VA, 20191, US

(21) Appl. No.: 12/205,065

(22) Filed: Sep. 5, 2008

(30) Foreign Application Priority Data
Sep. 12, 2007 (SG) 200708774-5

(51) Int. Cl. G06Q 90/00

(52) U.S. Cl. 705/7

(57) ABSTRACT

There is disclosed a method for assessing and managing risk within a process comprising:
(i) receiving data relating to a probability (P) of two or more mishaps occurring within said process, and data relating to a severity (S) of two or more mishaps occurring within the process;
(ii) defining a range of probability (P) values and severity (S) values as the span from the minimum to maximum values received;
(iii) defining a range of risk (R) as the products of the minimum and maximum (P) and (S) values;
(iv) obtaining logarithmic values of probability (P), severity (S), and risk (R) and scaling the ranges of the logarithmic values such that (P), (S), and (R) values are represented as percentages (0-100%);
(v) determining a percentage of any values of P and S specified at intermediate stations within their respective ranges;
(vi) computing a percentage, rank and value of risk (R) for any intermediate combination of probability (P) and severity (S) values specified; and,
(vii) comparing the computed risk results against acceptable and unacceptable criteria to determine whether the risk is tolerable, and hence to be managed with suitable control scenarios.

### FIELD OF THE INVENTION

The present invention relates to a system and method for assessing the risk of a hazardous activity, event, or situation, and in particular, to a methodology and format for presenting the numerical values associated with such risks in tabular and graphical format for convenient documentation and visualisation.

### BACKGROUND

The ability to assess and manage risk is an important aspect of everyday life, particularly where certain activities may result in mishap. As such, risk assessment methods are now an established topic of theoretical analysis and practical management of hazards in any professional endeavour. Generally speaking, risk assessment takes into consideration the probability or likelihood of the mishap occurring, and the severity or consequences of that mishap, along with other relatively minor factors.

Historically, workplace mishaps have occurred and evoked the attention of concerned people throughout the history of human civilisation. In particular, records have shown that analyses of mining accidents have been carried out as early as 1941. However, risk assessment and control have become an important topic and management tool relatively recently, that is to say, in the past three decades.

While risk assessment and management have been closely tied to safety management systems and considered a prime tool for the elimination and mitigation of mishaps, it has been difficult to demonstrate a business case for investment in safety for many industries and professional activities, particularly those considered “low risk”. However, recent developments have shown that organisations and governments are convinced of the benefits of planned investment in risk assessment and resulting safeguards as a proactive defense against workplace mishaps and losses.

Risk assessment deals with the identification of hazards and the evaluation of the magnitude of the risks associated with such hazards. At the outset, it must be noted that any risk assessment can cover only a relevant portion—marked as “feasible danger” in FIG. 1—of the entire spectrum of risk in the activity or process or situation.

Typically most risk assessment methodologies consider that risk (R) is a function of a number of independent parameters, mainly probability (P) of occurrence of a mishap, and severity (S) of its consequence. Most proposed methodologies vary in the manner in which the combined effect of P and S is assessed and categorised.

To aid in evaluation and decision-making, the P, S, and R values may be plotted on a matrix (i.e. a table) with P and S along the vertical and horizontal axes (or vice versa) and each particular combination P and S being located in the table at the intersection of their specified levels, as in FIG. 2. This provides a visual representation of the risk level within the spectrum from the lowest to highest as represented by the matrix.

Commonly, a risk matrix is employed to display probability and severity levels by defined groupings, and qualitative descriptions are assigned to combinations of probability and severity to the different cells grouped into categories of risk, in a matrix format, as in FIG. 2. This is known as “Qualitative Risk Matrix”.

As an improvement over the qualitative method, numbers (“ranks”) may be assigned to the probability and severity levels (starting with ‘1’ for the lowest), and these level numbers may be multiplied or otherwise manipulated according to a variety of methods, to obtain the risk rankings, as in FIG. 3. The use of numbers simplifies communication and decision-making, although they do not confer actual value to the variables. The resulting risk matrix is referred to as “Numerical”, or “Pseudo-Quantitative”, latter meaning not really quantitative.

Where quantitative data is available for both (or all) parameters of risk, probabilistic and mathematical techniques are used to determine consequential risk in a quantitative fashion, and the resulting risk matrix is known as “Quantitative Risk Matrix”. Examples of quantitative data may be parts per million of a toxic component in drinking water, dollars cost per accident, etc. Academicians, scientists, practitioners, and administrators in this field have dealt with the mathematics and methodologies behind risk assessment and its application to risk management.

Where quantitative data is available for one (or a few) parameters of risk, or with relative values of various parameters (e.g. “medium” frequency of a mishap is three times as frequent as “low” frequency), the resulting risk matrix is referred to as “Semi-Quantitative”. This may involve some mathematical manipulations.

Obviously, where actual or relative values of P and S are available, the resulting R may be calculated and plotted to scale, to present a quantitative or semi-quantitative picture of the risk.

It has been recognised that plotting such values—which generally vary across wide spans—to an arithmetic scale often results in highly distorted locations of risk points. This may be particularly problematic when time scales vary from days to decades, and injury costs vary from a few dollars to millions of dollars. A resulting problem in the graphical representation of the risk plots is that contours of constant risk, represented as (P·S=Constant), will be in the form of hyperbolas, which are difficult to plot and interpret.

To overcome these disadvantages, a log-log plot (logP+logS=Constant) is often used such that the hyperbolas reduce to inclined straight lines, which are simpler to depict and easier to understand.

In most existing quantitative risk assessment and management systems, the manipulation of the data and the manner in which the data and results are graphically presented are not very user-friendly or easily interpretable by those unfamiliar with the intricate workings of the system.

As such, there is a need to provide an improved risk assessment and management system that enables simple qualitative and quantitative assessment of risks which can be readily understood and interpreted by users.

Any discussion of documents, act, materials, devices, articles or the like which have been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

According to a first aspect, the present invention provides a novel technique for organisation, presentation, analysis, and management of hazards involving risk level assessment and decision-making, based on standard hazard data including but not limited to the following:

(i) Receiving data relating to the probability (P) of two or more mishaps occurring within said process, and data relating to the severity (S) one of two or more mishaps occurring within the process;

(ii) Defining the ranges of probability and severity as the spans from their minimum to maximum values as specified;

(iii) Defining the range of resulting risk (R) as the products of the minimum and maximum values for P and S;

(iv) Scaling the ranges of the logarithmic values of probability (P), severity (S), and risk (R) such that P, S, and R values are now represented as percentages (0-100%), the said step being known as “normalisation”;

(v) Determining the percentage of any values of P and S specified as intermediate stations within their respective ranges;

(vi) Computing the percentage, rank and value of risk for any intermediate combination of probability and severity specified, through expressions derived from mathematical principles; and,

(vii) Comparing the risk results against acceptable and unacceptable criteria to determine whether the risk is tolerable, and hence to be managed with suitable control scenarios.

In one embodiment, expected to be the most common, data relating to probability (P) of mishaps occurring within said process may be in frequency units such as number of mishaps per year; or in levels of relative quantitative measures, along with brief descriptions. Likewise, data relating to the severity (S) associated with mishaps occurring within the process may be in cost units such as dollars cost per mishap, or in levels of relative quantitative measures, along with brief descriptions. From these values, the ranks and percentages will be calculated from the mathematical expressions developed.

In another embodiment, data relating to probability (P) and/or data relating to severity (S) may be only in the form of qualitative levels (referred to as ranks) for lack of definitive numerical values. In such cases, the method skips the step of determination of rank from value, and instead, directly goes to the step of scaling ranks to percentages, the rest of the process to compute and display R being the same as when actual or relative values are supplied.

The integration of inputs into the process, their normalisation, and subsequent evaluation are performed through known simple linear and exponential mathematical relationships between probability, severity, and risk states, specially manipulated to develop the following:

(a) Automatic 0-100% calibration of chosen danger range defined by the input minimum and maximum levels of probability and severity, and hence risk;

(b) Transformation of raw data and their manipulation to improved presentation in terms of percentages utilising established principles of exponential (that is, log-log) conversions;

(c) Expression of risk in dollars (or other currency) per year, or in other input quantitative measures, or in qualitative product terms, depending on the input; and,

(d) Determination of any one of the three variables probability, severity, and risk, given the other two, in terms of either actual values or percentages, depending on the data given.

According to a second aspect, the present invention provides a novel graphical format consisting of the following:

(a) A diamond shape for the risk domain, extent defined by the probability and severity levels input, as in FIG. 7(e). This diamond shape and the underlying exponential transformation lead to the name claimed and trademarked, as “SAFER Diamond”, ‘SAFER’ standing for ‘Safe And Feasible Exponential Risk’;

(b) The bottom corner taken as the origin for the risk zone, corresponding to “zero risk” (Lowest Feasible Danger, or LFD) as defined by the user;

(c) The top corner taken as the peak of the risk zone, corresponding to “100% risk” (Highest Feasible Danger, or HFD) as defined by the user;

(d) The left lower edge of the diamond representing P axis for probability percentages, and the right lower edge of the diamond representing S axis for severity percentages. (The two edge designations may be interchanged if the layout and/or data require it, without affecting the outcome.)

(e) The P and S inclined axes marked in percentages from 0% at the common bottom corner to 100% at the two top ends of the inclined axes, along the inclined edges, or along their horizontal and/or vertical projections;

(f) The vertical centre line from the bottom corner to the top corner representing the range of risk levels from 0% to 100%;

(g) Location of the “Lowest Tolerable Risk” or LTR level, and “Highest Tolerable Risk” or HTR level, as benchmark lines on the diamond;

(h) Mapping of desired probability, severity, and risk status of any hazard as points such as A in FIG. 7 on the diamond.

In one embodiment, the present invention may include the capability, from a single compact spreadsheet computer program, a sample screenshot of which is shown in FIG. 10, to compute all the necessary quantities from given data, and to present numerically and graphically the data and results in the formats described herein, leading to answers to practical questions such as the following:

(a) What is the expected risk loss for a certain combination of probability and severity?

(b) To achieve a desired risk protection, what investment (or insurance coverage) should be planned for? What P and S options are available to control risk within this limit?

(c) How are losses of the same value R incurred by two combinations of P and S different?

(d) If the project can afford only x dollars for risk protection, what risk percentage must be set as “Unacceptable Risk Limit”?

(e) If risk loss below y dollars is insignificant in the overall budget, what risk percentage may be set as the “Acceptable Risk Limit”?

(f) To reduce the risk of a certain hazard scenario to a desired level, if probability can be reduced by P units, then, by how many units S of severity should the hazard be reduced (or, perhaps, even be allowed to increase)? Or vice versa?

It will be appreciated that the SAFER Diamond is a versatile interactive tool combining sound risk analysis principles, providing the following features and benefits:

(a) A numerical as well as graphical interactive tool to map historical data and planned scenarios, and thus manage present problems and guide future directions;

(b) Elimination of the constraints in current practice, such as:
(i) Use of ranges of variables to define a danger state;
(ii) Fixed number of P and S range segments, and hence fixed number of risk cells;
(iii) Fixed number of risk categories; and,
(iv) Necessity to define clearly various levels of probability and severity and categories of risk, to avoid ambiguity.

(c) The invention overcomes the above-listed constraints by:
(i) Developing all the necessary variations uniquely to scale from just two end values or levels of P and S; and,
(ii) Providing continuous instead of step-wise functionality.

(d) Potential to integrate to a common convenient base, with a standardised format and scope of risk assessment, the present wide variety of format and scope of risk matrices in use around the world which militate against proper comparisons of risk findings from different sources;

(e) Potential to be a handy and convenient device for experimenting with and evaluating various risk management scenarios;

(f) Potential to add one or more factors (beyond P and S) governing risk with the same methodology and format as the present 2D (two-parameter) case presented;

(g) Potential to apply not only to industrial and workplace risk, but also to financial and other losses;

### BRIEF DESCRIPTION OF THE DRAWINGS

By way of example only, certain parts of prior work and preferred embodiments of the current invention will be illustrated by the accompanying drawings:

FIG. 1—shows terminology used in the invention and associated discussion;

FIG. 2—shows a typical qualitative risk matrix in accordance with established risk assessment processes;

FIG. 3—shows a typical method of applying numerical ranking to the qualitative risk matrix of FIG. 2;

FIG. 4—is a probability and severity plot to an arithmetic scale showing the wide spread in the data;

FIG. 5(a)—shows a linear plot of a 4 by 6 units data matrix displaying hyperbolic contours of constant risk;

FIG. 5(b)—shows a logarithmic plot of the same data as in FIG. (5(a);

FIG. 6—shows (a) a risk matrix, (b) hyperbolic zones and (c) a log-log plot by prior art systems used to represent data and results for risk assessment;

FIG. 7—shows the steps in the evolution of one embodiment of the method of the present invention; FIGS. 7(a) and 7(b) are essentially the same as FIGS. 5(a) and 5(b) repeated for completeness of the evolution sequence;

FIG. 8—shows the step in one embodiment of the present invention corresponding to the scaled alteration of a rectangle log-log plot to a square log-log plot;

FIG. 9—shows the step in one embodiment of the present invention corresponding to the rotation of a square by 45 degrees counter-clockwise to a diamond shape; and,

FIG. 10—shows a screen shot of one embodiment of a spreadsheet application of the present invention.

### DETAILED DESCRIPTION OF PREFERRED EMBODIMENTS

### Terminology Used

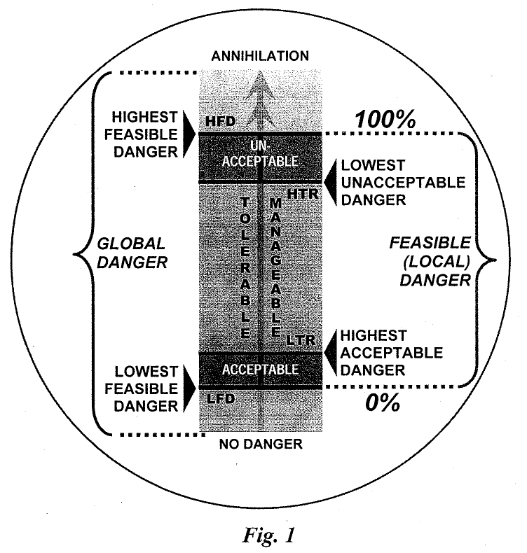

Whilst standard terminology exists in the art of workplace risk management, for reasons of clarity and by way of example only, the following terms used within the description are explained, with reference mainly to FIG. 1.

Danger

The word “danger” will encompass risk and its two major components, probability and severity. “Hazard” generally refers to potential danger, which becomes risk only when it is realised to the personnel or assets under consideration within the defined scope of analysis. The danger is real when it can possibly lead to adverse events like accidents or losses, or when it can result in long-term adverse consequences—all of which will be together referred to as “mishaps”.

Global Danger

This term covers the entire spectrum of dangers from no danger to complete annihilation, both end conditions being not fully identifiable. Global danger is an indefinable abstraction, and is mentioned here only to emphasise the fact that any and every activity in the real world will carry some risk, and also will not be exposed to all risk.

Feasible Danger

This term represents a sub-set of the global danger, covering only “feasible” (practically realisable) dangers, that is “credible” (believable) dangers, and/or “local” (as against “global”) dangers chosen for analysis, namely dangers whose probability and severity and hence risk are relevant to the user. This is the danger range over which the user wishes to, can, and must exercise control, through risk assessment and management. The word “user” will refer to any individual or organisation (such as a company or government) which will assess and manage the risks involved in their project or task.

Lowest Feasible Danger (LFD) Level

The LFD level is the bottom level of feasible danger, below which dangers will be irrelevant, as decided by the user. This term can be defined as the user's “Zero (0%) danger” state, representing the “minimum or lowest” level of dangers assessed. This zero danger is not complete absence of danger, but refers to the irrelevance and insignificance to the user, of any smaller danger up to that point.

Highest Feasible Danger (HFD) Level

The HFD level is the top level of feasible danger, above which dangers will again be irrelevant, as decided by the user. This will be defined as the user's “100% danger” state, representing the “maximum or highest” level of dangers assessed. This 100% danger is not the ultimate danger state, but refers to the undesirability to and uncontrollability by the user, of any larger danger beyond that point.

Highest Acceptable Danger

This term refers to the level of danger, within the feasible range, below which the danger may be considered acceptable as a normal and routine part of the work, not deserving of investment of time, effort, or funds for further control by the user.

Lowest Unacceptable Danger

This term refers to the level of danger, within the feasible range, above which the danger must be considered unacceptable even as an occasional or tolerable part of the work, any further investment of time, effort, or funds for further control lying beyond the capability of the user.

Risk Categories

Risk is the combination of probability of occurrence and severity of consequence and any other factors contributing to a mishap. Risk is broadly divided into three categories:

(i) Acceptable risk:
The lower zone in feasible danger, bounded by the HFD and the lowest unacceptable danger.

(ii) Unacceptable risk:
The upper zone in feasible danger, bounded by the LFD and the highest acceptable danger.

(iii) Tolerable risk:
The middle zone in feasible danger, bounded by the highest acceptable danger and the lowest unacceptable danger, and refers to the manageable part of feasible danger.

Lowest Tolerable Risk (LTR)

The term LTR arises from the highest acceptable danger and roughly corresponds to the “Lower ALARP Limit” in existing risk assessment methodologies. “ALARP” itself refers to “As Low As Reasonably Practicable”, represented graphically as an inverted triangle with the apex at the bottom and width increasing with increasing height corresponding to increasing risk, and also often shown divided into three zones similar to risk categories already described.

Highest Tolerable Risk (HTR)

The term HTR arises from the lowest unacceptable danger and roughly corresponds to the “Higher ALARP Limit” in existing risk assessment methodologies.

Rank of Danger

Gradations of probability, severity, and risk may be done qualitatively as “Low”, “Medium”, “High”, etc., or with other equivalent terms such as “Minor”, “Moderate”, “Major”, etc. Alternatively, they may be graded numerically as ‘1’, ‘2’, ‘3’, . . . . When numbers are used, they may or may not refer to actual values (e.g. probability of ‘3’ may not mean 3 times a year) or even relative values (e.g. severity of a fracture assigned rank ‘2’ will be many times more painful or costly than just twice as painful or costly as for a bruise which may be assigned rank ‘1’). The word “Rank” will herein be used to denote the order of magnitude of any aspect of danger, with the implication that smaller numbers will refer to less danger (unless otherwise specified). It will also be used specifically to refer to the logarithm (to the base 10) of a number; thus, 100 being 10², 2 will be the rank of 100.

As will be apparent from the description below, the present invention is directed to extending the known systems and methods of assessing the risk of any hazardous activity or situation so as to improve the application of the principles applied therein in an easier and quicker fashion. The present invention develops mathematical relationships from existing principles to enable risk assessment of a wider class of problems than previously possible, and their comparison on a common base.

The mathematics and methodologies behind existing risk assessment and risk management systems and methods are based on the principle that risk (R) is a function of a number of independent parameters, mainly probability (P) of occurrence of a mishap and severity (S) of its consequence.

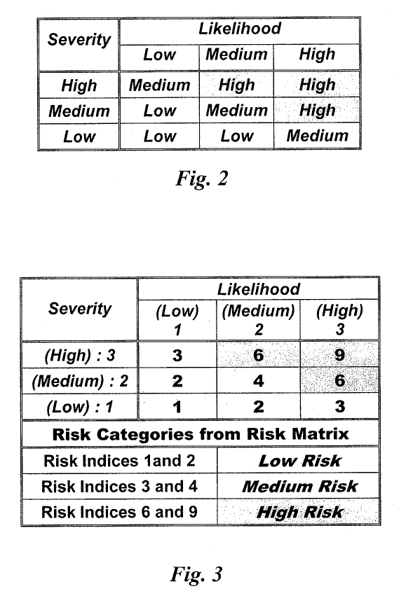

The combined effect of P and S may be assessed and categorised in a variety of ways. These may include:
(i) Locating a risk as the intersection of probability and severity in a risk matrix, and assigning qualitative descriptions to groups of cells in the risk matrix, as shown in FIG. 2;
(ii) Assigning numbers (“ranks”) to probability and severity levels (starting with 1 for the lowest) and then taking the average of the two levels—or adding 0.5 to the lower of the two levels;
(iii) Adding the probability and severity ranks;
(iv) Multiplying the probability and severity ranks as shown in FIG. 3—which is the most common practice.

Risk categories may then be broadly assigned as previously described, for example, “acceptable” (‘Low’), “tolerable” (‘Medium’), and “unacceptable” (‘High’). Appropriate controls can then be established to:
(i) Set aside the acceptable risks, unless and until they deteriorate into tolerable or unacceptable risks;
(ii) Manage the tolerable risks by elimination or mitigation according to a hierarchy of controls;
(iii) Avoid the unacceptable risks until they are brought down to tolerable or acceptable levels.

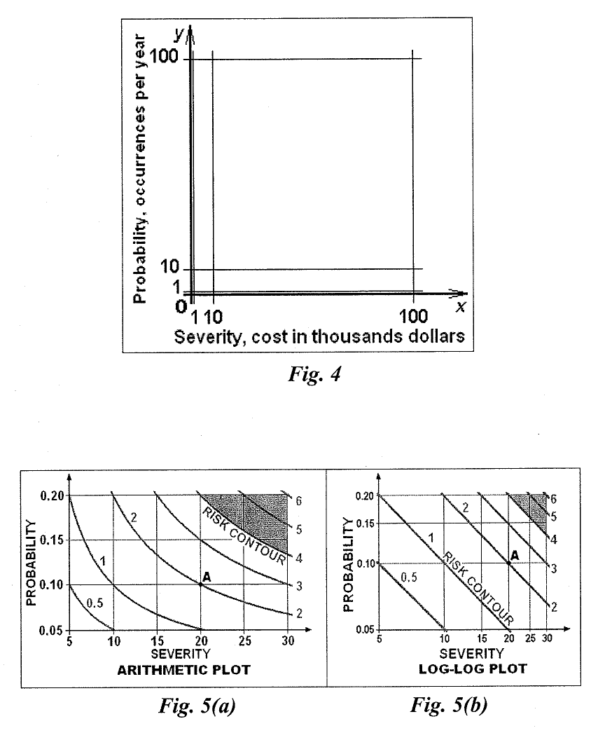

In order to provide a visual representation, a plot of probability (P) and severity (S) values to arithmetic scale may be developed. As is shown in FIG. 4, in instances where time scales vary from days to decades, and injury or damage costs vary from a few dollars to millions of dollars, the location of practical risk points within the plot can vary widely. As such, generally the plot is highly distorted.

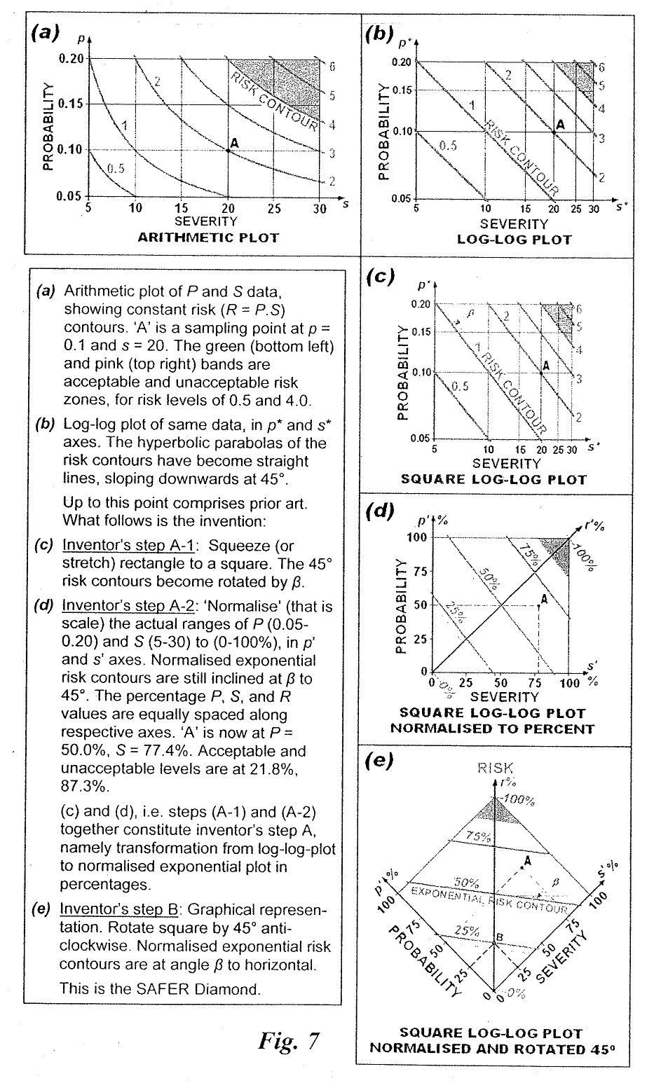

Further, with risk being usually taken as the product of probability and severity, contours of constant products (P·S) representing constant risk, will be hyperbolas. [Note that the full stop between the variables will denote multiplication.] As well as being difficult to interpret mathematically, such contours are also very difficult to plot and/or visualise from most graphical representations. This is shown in FIG. 5(a) and FIG. 7(a), which depict a linear plot of a 4 by 6 unit data matrix, with hyperbolic contours of constant risk in arithmetic plot. Basic risk categories are shown as shaded bands.

To address these problems, particularly where wide variations in probability and severity exist, a log-log plot is used.

In such a log-log plot, the hyperbolas are reduced to inclined straight lines, which are simpler to depict and easier to understand. FIG. 5(b) and FIG. 7(b) depict such a log-log plot for the same situation as in the corresponding arithmetic plots of FIG. 5(a) and FIG. 7(a). For equal scales along both log axes, the risk contours will be at 45°. Note that the exponentiation shifts the values and hence the contours towards the higher end. Risk increases from the origin, namely the bottom left corner of FIG. 5(b), towards the opposite, namely the top right, corner. Assignment of risk categories in the risk matrix is often made bearing in mind this hyperbolic variation of risk contours.

Most of the current risk assessment work is done using the risk matrix format in qualitative terms (FIG. 2) or with their numerical equivalents (FIG. 3). The use of the numerical equivalents is generally preferred over the use of qualitative terms due to the ease of communication to and use by the lower echelons of organisations. Plots such as those shown in FIG. 5 are not generally used as commonly.

It will be appreciated that a variety of computer programs and spreadsheet packages has been developed to carry out the simple computations discussed above. Programs are also able to graphically display the results to develop requisite presentations. Expert systems have been occasionally invoked for specific applications to broaden the use of the risk matrix.

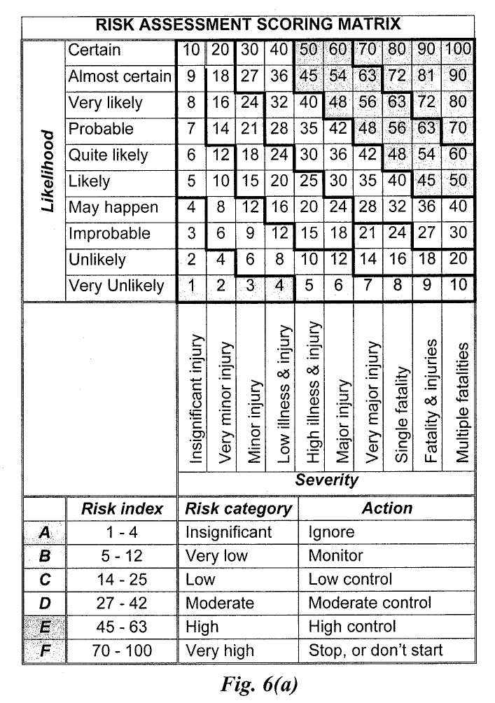

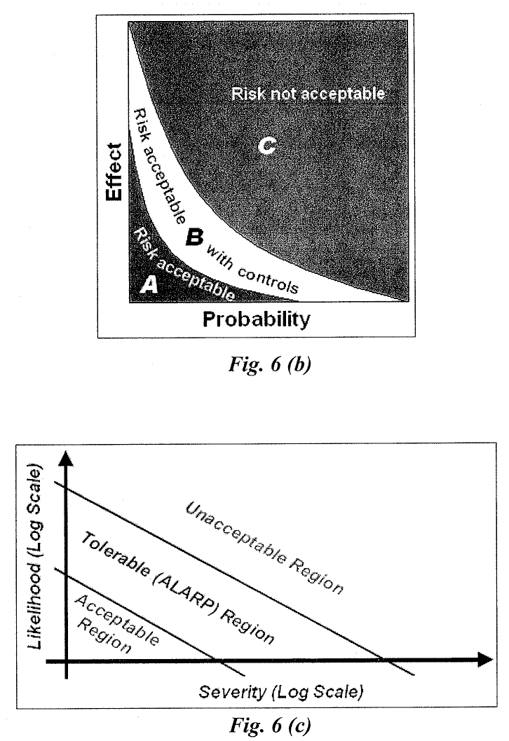

Recently, as risk assessment has become widely accepted as the leading indicator of safety management systems, the general assessment procedures have been formalised, and standard risk assessment forms and procedures have come into routine use. FIG. 6 shows examples of such a formalisation of the risk matrix, hyperbolic zones, and log-log plots described above. It will be appreciated that the use of the term “effect” in FIG. 6(b) is analogous to the use of the term “severity” in accordance with the terminology used herein.

Thus, the risk matrix is typically the most common risk assessment technique used, with other mathematical treatments being reserved for specialised situations.

As previously stated, the present invention uses mathematical relationships developed from the above described existing principles, and provides a methodology and format to present the numerical values in tabular and graphical format for convenient documentation and visualisation.

This is achieved by integrating the inputs of probability (P) and severity (S) of any hazardous task and calibrating them to a 0-100% scale between the two ends of each of the ranges given. Assessment of the task risk (R) can then be developed as a combination of P and S, in both percentage scale and in original units.

Forward and backward computational capabilities of the system of the present invention enable the determination of any one of the three prime variables (P, S, and R) either in raw data form or in percentages.

The graphical format of the present invention also provides a unique presentation in a diamond shape, which, like the ALARP triangle, shows risk increasing from the bottom towards the top. The ALARP triangle is mostly a qualitative method, with numerical LTR and HTR bounds occasionally marked as visual cues, although not to any scale. However, the diamond-shaped risk zone is a considerable improvement over existing representations as it offers extensive quantitative significance and the ability to be explored in an interactive fashion.

To assist in understanding the manner in which the method and system of the present invention departs from existing methodologies, reference is made to FIG. 7.

FIG. 7(a) shows an arithmetic plot of P and S data which is typical of conventional methodologies described above. The plot shows constant risk (R=P·S) contours in the form of hyperbolic parabolas. A is a sampling point at P=0.1 and S=20. The shaded bands are acceptable and unacceptable risk zones, for risk levels of 0.5 and 4.0.

FIG. 7(b) shows a log-log plot of the same data in P*(=log P) and S*(=log S) axes, in accordance with known methods. The hyperbolic parabolas of the risk contours have become straight lines, sloping downwards at 45°.

Each of the steps utilised to generate graphs (a) and (b) of FIG. 7 are standard prior art methods. Subsequent representations (c), (d), and (e) of FIG. 7 depict the substance of the present invention.

FIG. 7(c) shows the modification of the plot by (squeezing or stretching), such that the rectangular plot of graph (b) becomes a square. This is referred to as Step A-1 in the invention. In doing so, the 45° risk contours become rotated by an angle β.

FIG. 7(d) shows the scaling (“normalisation”) of the actual ranges of P (0.05 to 0.20) and S (5 to 30) to 0-100% along both P′ and S′ axes. This is referred to as Step A-2 in the invention. The normalised exponential risk contours are still inclined at angle β to 45°. The percentage P, S, and R values are now equally spaced along respective axes.

As a result of this process, sampling point A is now at P=50.0% and S=77.4%. For comparison, acceptable and unacceptable levels are marked, at 21.8% and 87.3% respectively.

The steps of the present invention described to obtain graphs (c) and (d) enable the transformation from a log-log plot to a normalised exponential plot displayed in percentages, which is a considerable improvement over existing methodologies. These are referred to as steps A-1 and A-2 in the invention.

FIG. 7(e) shows the rotation of the graph (d) by 45° anti-clockwise, by which the plot assumes a diamond shape with the normalised exponential risk contours being at angle β to horizontal. This diamond graphical representation, represented as step B in the invention, is a considerable improvement over existing graphical representations and offers considerable quantitative significance as well as an ability to be evaluated in an interactive fashion.

The computations involved in the invention are presented in the mathematical development below.

### Mathematical Treatment

An embodiment of the present invention, including a worked example presented in parts, is provided below. To assist in understanding, notations of variables used are defined as follows:
P, S, R=Value of probability, severity, and risk; also used as subscript for probability, severity, and risk
P*, S*, R*=“Rank” i.e. log to base 10, of probability, severity, and risk
P′, S′, R′=Percentage for the rank, that is, for normalised exponential value of probability, severity, and risk
C=Scaling factor for converting log-log value to normalised percentage
Subscript L=Lowest feasible value
Subscript H=Highest feasible value
Subscript HL=Range from lowest to highest values, ranks, or percentages, i.e. (highest value, rank, or % age)−(lowest value, rank, or % age), for probability, severity, or risk
Subscript i=I-th state, intermediate between L and H
Subscript iL=Range from lowest to intermediate values, ranks, or percentages, i.e. (intermediate value, rank, or % age)-(lowest value, rank, or % age), for probability, severity, or risk

### (a) Forward Computation of Percentages:

(i) Values to Ranks:

The conventional method of multiplying actual probability (P) and severity (S) values to obtain the risk value (R) may be represented as:

R=P·S (1)

As discussed previously in relation to existing methodologies, as in many real-life problems the variations in the intervals for probability and severity are generally exponential, it will be more convenient to transform Eq. (1) to its log-log equivalent as follows:

log R=log P+log S (2a)

or, R*=P*+S* (2b)

When quantitative data is not available, the relative orders of magnitude (“ranks”) may be input as the equivalents of log values. In such case, the results will also be in relative terms.

In the log-log domain, risk contours, namely the loci of specified values of R*(=P*+S*), will be 45′ lines sloping downwards, as depicted in FIG. 5(b) or FIG. 7(b).

(ii) Ranks to Percentages:

The normalisation functions connecting the percentages Pᵢ′ and Sᵢ′ and consequent risk Rᵢ′, with the corresponding ranks Pᵢ*, Sᵢ*, and Rᵢ* combine the two steps that achieve graphs (c) and (d) of FIG. 7, and will be as follows:

Pᵢ′=100(Pᵢ*−P_{L}*)/(P_{H}*−P_{L}*), which may be compactly written:

Pᵢ′=100(P_{iL}*/P_{HL}*)=C_{P}·P_{iL}*, with C_{P}=100/P_{HL}* (3a)

Also, Sᵢ′=100(S_{iL}*/S_{HL}*)=C_{S}·S_{iL}*, with C_{S}=100/S_{HL}* (3b)

Rᵢ′=100(R_{iL}*/R_{HL}*)=C_{R}·R_{iL}*, with C_{R}=100/R_{HL}* (3c)

C_{P}, C_{S}, and C_{R} may be thought of as “Scaling factors” to convert respective ranks to percentages.

### Example

### Part 1

Probability:
Given probability values: P_{L}=once a year=1/365=0.00274 mishap per day, P_{H}=once a week=1/7=0.143 mishap per day, and, Pᵢ=once a month=1/30=0.0333 mishap per day
Hence, P_{L}*=log 0.00274=−2.562, P_{H}*=log 0.143=−0.845, and, Pᵢ*=log 0.0333=−1.478
P_{HL}*=−0.845−(−2.562)=1.717
By Eq. (3a), C_{P}=100/1.717=58.2
Then, obviously, P_{L}′=0, and P_{H}′=58.2×1.717=100%
Intermediate point Pᵢ′=58.2[−1.478−(−2.562)]=58.2×1.084=63.1%

Severity:
Again, given severity values: Cost per mishap, S_{L}=$200, S_{H}=$50000, and, Sᵢ=$8000
Hence, S_{L}*=log 200=2.301, S_{H}*=log 50000=4.699, and, Sᵢ*=log 8000=3.903
S_{HL}*=4.699−2.301=2.398
By Eq. (3b), C_{S}=100/2.398=41.7
Then, obviously, S_{L}′=0, and S_{H}′=41.7×2.398=100%
Intermediate point Sᵢ′=41.7 (3.903−2.301)=41.7×1.602=66.8%

Risk:
Note that risk=(mishaps per day). (dollars per mishap)=Dollars per day
Thus, R_{L}=0.00274×200=$0.55 per day, R_{H}=0.143×50000=$7150 per day, and Rᵢ=0.0333×8000=$267 per day.
Ranks for the consequent risk: R_{L}*=−2.562+2.301=−0.261, R_{H}*=−0.845+4.699=3.854, and, Rᵢ*=−1.478+3.903=2.425;
R_{HL}*=3.854−(−0.261)=4.115
By Eq. (3c), C_{R}=100/4.115=24.3
Intermediate point value Rᵢ′=24.3[2.425−(−0.261)]=65.3%

(iii) Inter-Relationships Between Rank Ranges and Scaling Factors:

It may easily be confirmed that at LFD level, Pᵢ*=P_{L}*, Sᵢ*=S_{L}* and Rᵢ*=R_{L}*, and Pᵢ′, Sᵢ′, and Rᵢ′ reduce to 0%. At HFD level, Pᵢ*=P_{H}*, Sᵢ*=S_{H}*, and Rᵢ*=R_{H}*, and Pᵢ′, Sᵢ′, and Rᵢ′ reduce to 100%.

From R_{L}*=P_{L}*+S_{L}*, and R_{H}*=P_{H}*+S_{H}*,

we have: R_{H}*−R_{L}*=(P_{H}*+S_{H}*)−(P_{L}*+S_{L}*)=(P_{H}*−P_{L}*)+(S_{H}*−S_{L}*)

i.e. R_{HL}*=P_{HL}*+S_{HL}* (4a)

Hence, from Eq. (3a, b),

100/C_{R}=100/C_{P}+100/C_{S}=100(C_{P}+C_{S})/(C_{P}·C_{S})

or, C_{R}=C_{P}·C_{S}/(C_{P}+C_{S}) (4b)

which is an alternative expression for C_{R}=100/R_{HL}* in Eq. (3c).

### Example

### Continued, Part 2

P_{HL}*+S_{HL}*=1.717+2.398=4.115=R_{HL}*, confirming Eq. (4a)
By Eq. (4b), C_{R}=(58.241×41.702)/(58.241+41.702)=24.3 also, confirming earlier computed value.

### (b) Relationships Between P, S, and R Percentages:

Noting that Rᵢ*=Pᵢ*+Sᵢ*, Eq. (3c) may be written, after rearrangement of the terms:

Rᵢ′=100(P_{iL}*+S_{iL}*)/R_{HL}* (5a)

From Eq. (3a) and (3b), this may be re-written in the alternative form:

Rᵢ′=(Pᵢ′·P_{HL}*+Sᵢ′·S_{HL}*)/R_{HL}* (5b)

### Example

### Continued, Part 3

From Eq. (5a),
Rᵢ′=100×{[(−1.478)−(−2.562)]+[3.903−2.301]}/4.115=65.3%
Again, from Eq. (5b),
Rᵢ′=(63.1×1.717+66.8×2.398)/4.115=65.3% also

In the form Eq. (5b), we may note that the risk percentage is simply a weighted average of the probability and severity percentages, the contribution of each factor being proportional to its rank range.

It also offers a method to compute the risk percentage from the probability and severity percentages.

Just as Eq. (5b) relates Rᵢ to Pᵢ′ and Sᵢ′, it may be rearranged to give Pᵢ′ or Sᵢ′ in terms of the other two variables, as follows:

Pᵢ′=[Rᵢ′·(P_{HL}*+S_{HL}*)−Sᵢ′·S_{HL}*]/P_{HL}*=(Rᵢ′·R_{HL}*−Sᵢ′·S_{HL}*)/P_{HL}* (5c)

Sᵢ′=[Rᵢ′·(P_{HL}*+S_{HL}*)−Pᵢ′·P_{HL}*]/S_{HL}*=(Rᵢ′·R_{HL}*−Pᵢ′·P_{HL}*)/S_{HL}* (5d)

### Example

### Continued, Part 4

From Eq. (5c) we get: Pᵢ′=(65.3×4.115−66.8×2.398)}/1.717=63.2, close to original value 63.1, the difference attributable to too few decimal places carried.
From Eq. (5d) we get: Sᵢ′=(65.3×4.115−63.1×1.717)}/2.398=66.9, close to original value 66.8, the difference attributable to too few decimal places carried.
Question: What should be the severity percentage level for a job J with 60% probability, to retain the risk at 50%?
From Eq. (5d), we get: Sⱼ′=(50×4.115−60×1.717)}/2.398=42.8%

### (c) Normalised Risk Contours:

The normalisation of widely disparate P and S ranges to the same percentage range of 0-100% affects the orientation of the exponential risk contours. This is explained as follows.

If the rank ranges of P and S are equal, that is if P_{HL}* equals S_{HL}*, meaning if the log-log plot FIG. 7(b) is already a square, then the modification Step A-1 will not be necessary, and the exponential risk contours will remain at 45° to the horizontal.

In the general case however, probability and severity are quite different entities, and their rank ranges may well be different. When normalisation changes the rectangle log-log plot into a square plot, the risk contours will rotate from their 45° orientation.

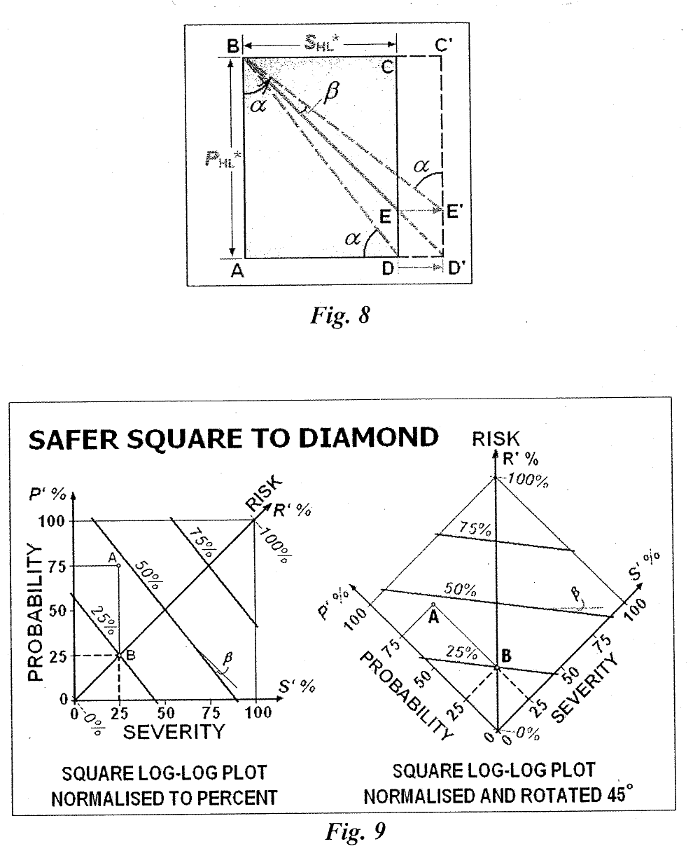

FIG. 8 shows the rank rectangle ABCD being changed to the risk square ABC′D′. The 45° risk contour BE, shown extended to D′, moves to the position BE′.

Noting that:
in the rectangle ABCD, AB=P_{HL}*, BC=S_{HL}*,
in the square ABC′D′, BC′=AB=P_{HL}*, and,
C′E′=CD′−E′D′=AD′−DD′=AD=S_{HL}*, we get,
Angle α=Angle ABE′=BE′C′=tan⁻¹(BC′/C′E′)=tan⁻¹(AB/AD)=tan⁻¹(P_{HL}*/S_{HL}*)
Angle of rotation of risk contour AE,
β=EBE′=ABE′−ABE=α−45°, that is,

β=[tan⁻¹(P_{HL}*/S_{HL}*)−45°] (6)

with the usual convention that counter-clockwise rotation is considered positive.

Counter-clockwise rotation (+ve β) signifies that the probability rank covers a wider range than severity rank. Clockwise rotation (−ve β) is the reverse, the severity rank range being the wider.

### Example

### Continued, Part 5

From Eq. (6) we get: β=−[45°−tan⁻¹(1.717/2.398)]=9.4,
the negative sign denoting that the rotation is clockwise from the horizontal

Clockwise inclination (−ve β) signifies that the severity estimates are more refined, spanning over a wider rank range, than the probability estimates. Counter-clockwise inclination is the reverse, the probability estimates being the more refined.

This rotation of the risk contour from the horizontal need not be considered a disadvantage. The slope of the contours also provides a visual cue, if not a warning, of the unbalanced refinement between probability estimates and severity estimates.

It will be appreciated that the more skewed the contours, the more the unbalance between the probability and severity estimates. Hence the user may re-examine the analysis if such unbalanced refinement is warranted, and try to make the P and S ranges as nearly equal as possible.

(d) Reverse Computation of Levels from Percentages:

(i) Percentage to Rank:

By rearranging Esq., (3a, b, and c), we get:

Pᵢ*=P_{L}*+Pᵢ′/C_{P} (7a)

Sᵢ*=S_{L}*+Sᵢ′/C_{S} (7b)

Rᵢ*=R_{L}*+Rᵢ′/C_{R} (7c)

(ii) Rank to Value:

By taking antilog of Eq. (7a, b, and c), we get:

Pᵢ=10̂Pᵢ* (8a)

Sᵢ=10̂Sᵢ* (8b)

Rᵢ=10̂Rᵢ* (8c)

Needless to say, Eqs. (7) and (8) may be combined into a single step, as:

Pᵢ=10̂(P_{L}*+Pᵢ′/C_{P}) (9a)

Sᵢ=10̂(S_{L}*+Sᵢ′/C_{S}) (9b)

Rᵢ=10̂(R_{L}*+Rᵢ′/C_{R}) (9c)

Equations (7) to (9) give us a method to determine ranks and actual values of probability, severity, and risk, from their respective percentages, thus enabling decision making on the consequences of various scenarios. It is also clear that, Rᵢ=Pᵢ·Sᵢ.

### Example

### Continued, Part 6

The actual values for the given feasible percentage danger limits in Example, Part 4, i.e. for a Pᵢ=60%, Sᵢ=42.8% and Rᵢ=50%, may be determined from Eq. (9) as:
Pᵢ=10̂(−2.562+60/58.2)=10̂(−1.531)=0.0294 mishap per day,
   i.e. 1 mishap in 34 days
Sᵢ=10̂(2.301+42.8/41.7)=10̂3.327=$2125 Per mishap
Rᵢ=10̂(−0.261+50/24.3)=10̂1.797=$62.60 Per day
Also, since Rᵢ=Pᵢ·Sᵢ, we find, 0.0294×2125=$62.60 per day, as above.
Further decisions may now be made on whether this cost is tolerable or not.

Many more permutations and combinations of data and computations are possible, all of which may aid in the understanding of the problem, evaluation of the sensitivity of the outcome to changes in the various parameters, etc.

Forms may be prepared for submission of data and also entry of hand-calculated or machine-computed results in a convenient format, by officials concerned.

### Graphical Representation of Data and Results

Graphical representation of results is generally the best way to add a physical significance to the numbers and variables, and to enable better understanding of the problem and better management of the solution.

In current practice, the risk matrix rectangle is the usual format in which the dangers for various job steps are mapped, so that the risk status may be visually evaluated.

In accordance with the present invention, graphical representation is achieved by rotation of the risk square (following invention Step A-1, the modification of the rectangular log-log plot of values to a square plot, and invention Step A-2, scaling to represent percentages of P*, S*, and R*) by 45° counter-clockwise as shown in FIG. 9, constituting the invention Step B.

Such a graphical representation provides the following benefits:

1. The P* and S* axes are both at 45° to the vertical, confirming their equal status as independent variables, in contrast to the conventional horizontal-vertical independent-dependent representation, which invariably implies that the vertical variable is dependent on the horizontal variable.

2. The combination of P* and S* giving the risk R*, can now be actually represented to scale (as at A in FIG. 9) instead of requiring a third axis perpendicular to the P-S plane for 3D format, or simply entered textually or symbolically in the P-S plane.

3. The risk axis being vertical, provides a visual measure of low or high risk for any status point located in the domain.

4. If in addition the tolerable risk limits LTR and HTR are marked on the diagram, the acceptability or otherwise of the risk status under evaluation is immediately recognisable visually.

5. The fact that in the general case the risk contours will be inclined to the horizontal by the angle β itself is an advantage in that it would clearly show that even for different scenarios for which the risk value (e.g. loss in dollars per day) is the same, the percentage risk may be quite different. As shown in FIG. 9, the three points A, A′, and A″, with components (75% P+25% S), (50% P+50% S), and (25% P+75% S), may appear to have the same total loss, averaging 50%. In fact all three points are at the same horizontal level in the diamond. However, from the figure, it may be clearly seen that risk A is less than 50%, risk A′ is exactly 50%, and risk A″ is more than 50%! Whilst the mathematical approach would certainly confirm this, the visual warning is often more effective.

As the user becomes more familiar with this normalised diamond representation, more benefits may be anticipated.

It will be appreciated that although the above mathematical analysis of the data and the graphical representation of the results can be carried out manually (with some means of finding the logarithms of quantities), they can be more quickly, conveniently, and correctly performed by an appropriate computer software. Clearly, the computerisation of the two parts of the present invention will bring invaluable advantages to the method and system proposed. In the area of risk analysis and management.

The usefulness of computerisation both computationally and graphically is well established and there are numerous public domain and proprietary computer programs and packages available for risk management.

By presenting the system and method of the present invention in a computer package, the accuracy, speed, interactive processing, report facilitation, graphical manipulation, etc. of the present invention can be readily realised. This is particularly true with respect to the following:

1. As logs and angles are involved, both the computation and plotting are simplified and their accuracy ensured by the use of computers.

2. The graphical interactive mode may be expanded to not only statically map specified combinations of P and S, but also to dynamically display P, S, and R, as the cursor is moved within the diamond, so that snap evaluations and decisions may be made.

By way of example only, the present invention can be readily adapted for use with a version of a spreadsheet (using MS-EXCEL®) to illustrate the obvious benefits of the invention.

In one embodiment, the spreadsheet program may compute all desired quantities depending on data input, as per the equations discussed above. The unique advantage of spreadsheets is that change in any one input quantity is automatically and instantaneously carried through to all the steps which involve that quantity, with no further effort on the user's part. This permits the user to try out various scenarios interactively and decide the course of action based on the findings. Tabular results may be saved and presented on the same sheet or in subsequent sheets.

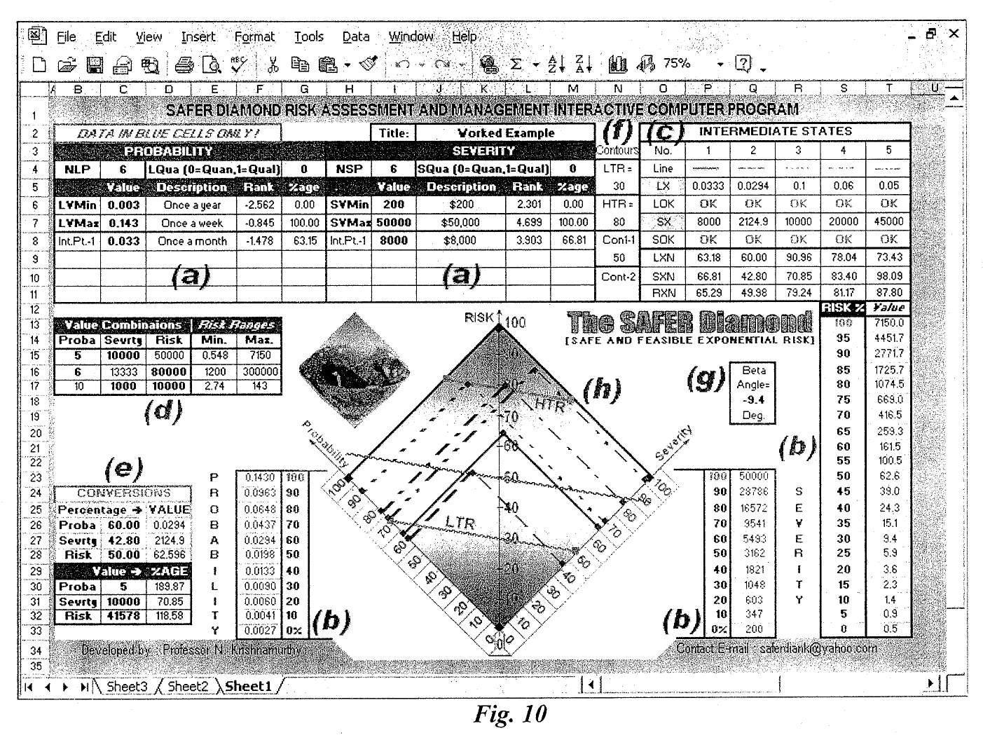

The screenshot in FIG. 10 shows the first or opening sheet of the program carrying the following details, with letters (a), (b), . . . in the list below corresponding to the designations marked on the picture:

(a) Echo of input data, and probability and severity values converted to ranks and percentages. [Note provision for qualitative data entry.]

(b) Tabulated percentages and actual values of P and S for every 10%, as well as the risk values R, for every 5%.

(c) Input and results for any risk desired to be computed and displayed on the diamond, for intermediate states with specified P* and S*.

(d) Computation of any of the three values P, S, and R, computed from other two values input.

(e) Conversions from percentage to value and vice versa, for P, S, and R.

(f) Input for LTR and HTR limit contours, and for two other specified contour values.

(g) Computed rotation angle β of risk contours.

(h) The SAFER Diamond, with input data points shown along the P* and S* axes, intermediate points (c) and contours (f) at angle β from (g).

Every item of input data is validated for consistency and feasibility, to prevent program crash, and to protect the user from misleading results from wrong data.

Additional sheet (or sheets) can supply more details in tabular form for the computations leading to the summary and graphics displayed on the first sheet.

The graphics can be further refined to provide for more interactive manipulation of data and display of results.

It will be appreciated that the present invention provides a novel quantitative and qualitative computational and presentation tool for risk assessment and management of diverse situations beset with mishap potential. As has been demonstrated, this is achieved by the invention comprising:

(A) A computational technique which normalises widely spread-out hazard data into a standard compact range on an exponent-based percentage scale, and computes inter-relationships between major risk factors for the safety analyst to investigate risk scenarios and to make feasible management decisions; and

(B) A mode of graphical presentation which interactively depicts various features of the analysis in a simple and convenient format built into and around a diamond-shaped risk zone.

The system and method of the present invention starts with a conventional combination of probability (P) and severity (S) to determine the risk (R) state, and thereupon automatically calibrates the P and S data from the minimum and maximum levels input by the user. The system and method of the present invention also compute all further required quantities forward or backward, providing numerical as well as graphical presentations to map the data and results, enabling quick practical decisions, resulting in an efficient management of risk.

It will be appreciated that the system and method of the present invention can serve as a handy and convenient device to analyse current problems, and to experiment with various risk management scenarios.

It will also be appreciated by persons skilled in the art that numerous variations and/or modifications may be made in the invention as suggested in the specific embodiments without departing from the spirit or scope of the invention as broadly described. The present embodiments are, therefore, to be considered in all respects as illustrative and not restrictive.

1. A method for assessing and managing risk within a process comprising:
(i) receiving data relating to the probability (P) of two or more mishaps occurring within said process, and data relating to the severity (S) of two or more mishaps occurring within the process;
(ii) defining ranges of probability (P) values and severity (S) values as the spans from the minimum to maximum values received;
(iii) defining risk (R) as the product of P and S values;
(iv) obtaining logarithmic values of probability (P), severity (S), and risk (R);
(v) scaling the ranges of the logarithmic values such that P, S, and R values are represented as percentages (0-100%);
(vi) computing the percentage, rank and value of risk (R) for any intermediate combination of probability (P) and severity (S) values specified;
(vii) converting any specified value of P, S, and R to percentage and vice-versa; and,
(viii) comparing the computed risk results against acceptable and unacceptable criteria to determine whether the risk is tolerable, and hence to be managed with suitable control scenarios.

2. A method according to claim 1, wherein the data relating to a probability (P) of two or more mishaps occurring within said process is in units such as number of mishaps per year, or in other actual or relative qualitative or quantitative measures, along with brief descriptions.

3. A method according to claim 1, wherein the data relating to a severity (S) of two or more mishaps occurring within the process is in units such as dollars cost per mishap, or in other actual or relative qualitative or quantitative measures, along with brief descriptions.

4. A method according to claim 1, wherein the risk (R) is evaluated from received data relating to probability (P) and severity (S) of mishaps at the two ends and intermediate values within the process.

5. A method according to claim 1, wherein the step of defining a range of resulting risk (R) values from said associated probability (P) and severity (S) data received may be extended to the computation of relative estimates of risk from qualitative data input in relative orders of magnitude, when quantitative measures are not available.

6. A method according to claim 1, wherein a feasible danger range is defined by the specified minimum and maximum levels of probability, severity, and risk.

7. A method according to claim 1, wherein, once the basic template has been set, forward or reverse computations to find any of P, S. and R given the other two, are enabled at the value, rank, or percentage level.

8. A computerised method according to claim, wherein, numerical and graphical results are displayed, and automatically re-computed and updated with revised inputs, for view and documentation;

9. A method according to claim 1, wherein, the invention enables and facilitates:
(i) Decision-making for the given data;
(ii) Projection of results for other estimated or synthetic data;
(iii) Experimentation for anticipated, feasible scenarios; and,
(iv) Integration of risk data and results for various enterprises world-wide; and,

10. A method according to claim 1, wherein, the potential has been created to apply the same methodology to include, in addition to probability P and severity S, additional parameters such as exposure, which may affect the risk level, with similar facility of computation and graphical presentation as obtained herein.
